(19) United States
(12) Patent Application Publication
(10) Pub. No.: US 2002/0128945 A1
(43) Pub. Date: Sep. 12, 2002

(54) Automated trading system

(76) Inventors: Peter Ian Moss, London (GB); David Martin Walters, London (GB); Edward Graham Pointer, London (GB)

Correspondence Address: PALMER & DODGE, LLP, KATHLEEN M. WILLIAMS, 111 HUNTINGTON AVENUE, BOSTON, MA, 02199, US

(21) Appl. No.: 09/753,755

(22) Filed: Jan. 3, 2001

(30) Foreign Application Priority Data
May 8, 1999 (GB) 9910588.4
Apr. 18, 2000 (GB) PCT/GB00/01507

(51) Int. Cl. G06F 17/60

(52) U.S. Cl. 705/37

(57) ABSTRACT

A computerised trading system for the trading of financial instruments or commodities which enables anonymous presentation of quotes on a workstation while still allowing the workstation to filter available quotes for display, on the basis of the nature of the originating party. A central server or network connects a plurality of workstations, each associated with a respective trading floor or institution. For each trading floor or institution, generalized institution status indicators are used to provide display filtration criteria, each indicator indicating a non-specific attribute of the respective institution.

The present invention relates to automated trading systems, and in particular to computer-implemented systems for trading in financial instruments such as foreign currency.

There are a number of automated trading systems described in the art in which a plurality of networked computer systems are used to distribute anonymous price quotes for dealing in foreign currencies or other financial instruments.

In a typical hierarchical system, each trader in a market operates from a computer workstation associated with a particular trading floor or institution. Each trader workstation for a particular trading floor is connected to a client site computer system which maintains data associated with that particular trading floor or institution and controls data flow to and from the individual workstations. Each client site computer is then connected to an independent market distributor computer system which distributes and analyses market data passing between the various client sites.

A trader workstation displays the relevant market information for the market in which that trader is operating, including details of available quotes in the form of bids and offers to enable the trader to execute trades, and also to make his own quotes according to the state of the market and his own institution clients.

In the prior art, various attempts have been made to reduce the burden on the individual trader at his workstation. For example, filtering or pre-processing the data displayed on the workstation so as to simplify the information presented to the trader has been described in the art.

In one example, the filtering operation involves displaying only a certain depth of the market corresponding to bids and offers close to the market touch point. In this system, the anonymity of the trader or institution making a quote can be maintained until the quote is accepted.

In the prior art, systems are also suggested to exercise a degree of intuitional control aver the activities of individual traders by providing for automated credit checking of the parties to a transaction before the trade can be completed. Credit checking can be effected after the parties have indicated a willingness to trade, when the identities of both parties are known to one another.

In U.S. Pat. No. 5,375,055, an automated trading system is adapted so that the best marker price details, together with the best dealable price of bids and offers made by parties are displayed. The best dealable price is provided by using quotes only from trading floors which have a credit authorization with the trader's own market floor and this reduces the quantity of redundant information which must be assimilated by the trader. The credit authorization is effected by reference to a pre-authorization matrix which determines on a simple “yes/no” basis which trading floors are entitled to trade with one another.

If anonymity of the trading floor making the quote is to be maintained, then the pre-authorization matrix must be maintained by (and credit checking procedure implemented by) a trusted third parry at a site remote from the client computer systems of either trading floor, eg. at the market distributor computer system.

If it is desired not to provide any explicit credit checking information to a third party, nor to reveal the identity of a party making a quote, then the prior art methods of filtering the data presented to the trader workstation based on credit checking are ineffective.

Thus it is an object of the present invention to provide an effective filtration method and apparatus which enables a reduction in the information to be presented to the trader on his workstation, while maintaining a capability for the originators of displayed market quotes to remain anonymous.

According to one aspect, the present invention provides a computerised trading system for the trading of financial instruments or commodities comprising:

a central server or network for connecting a plurality of workstations, each associated with a respective trading floor or institution;

means for storing a plurality of generalized institution status indicators in respect of each trading floor or institution, each indicator indicating a non-specific attribute of the respective institution;

a plurality of trader workstations each connected to the central server or network and associated with a respective institution, each workstation including

means for displaying current quotations in the market place including bids and offers, and

means for generating response messages indicating willingness to accept a bid or offer;

a database maintaining a list of current quotations active on the trading system, and

filtration means for applying selected filtration criteria to inhibit display of current market quotations at a given workstation, based on the value of one or more of said generalized institution status indicators.

According to another aspect, the present invention provides a computerised trading system for the trading of financial instruments or commodities comprising:

a central server for connecting a plurality of workstations;

a plurality of trader workstations each connected to the central server, each workstation including

means for generating quotations for transmittal to other workstations via said central server,

means for displaying current quotations in the market place including bids and offers, and

means for generating response messages to originating workstations indicating acceptance of a quotation;

a database maintaining a list of current quotations active on the trading system each quotation having associated therewith an ownership identification field indicating the identity of the originator of the active quotation, and a current keeper identification field indicating the identity of the workstation to which a quote acceptance message should be directed; and

means for modifying the current keeper identification field independent of the ownership identification field.

According to another aspect, the present invention provides a method of operating an automated trading system for the trading of financial instruments or commodities comprising the steps of:

connecting a plurality of workstations over a network, each workstation being associated with a respective trading floor or institution;

storing a plurality of generalized institution status indicators in respect of each trading floor or institution, each indicator indicating a non-specific attribute of the respective institution;

transmitting transaction data comprising quotations between said plurality of trader workstations over said network;

maintaining a database comprising a list of current quotations active on the trading system;

displaying, on at least one selected workstation, current quotations in the market place including bids and offers;

applying selected filtration criteria to inhibit display of current market quotations at said selected workstation, based on the value of one or more of said generalized institution status indicators.

Embodiments of the present invention will now be described by way of example with reference to the accompanying drawings in which:

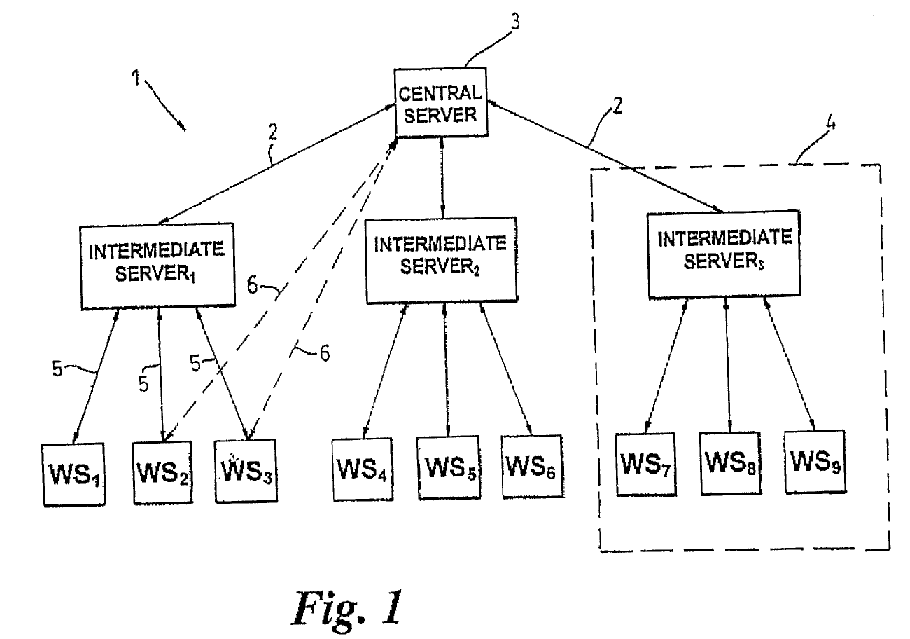

FIG. 1 is a schematic diagram of a hierarchical computerised trading system according to a presently preferred embodiment of the present invention;

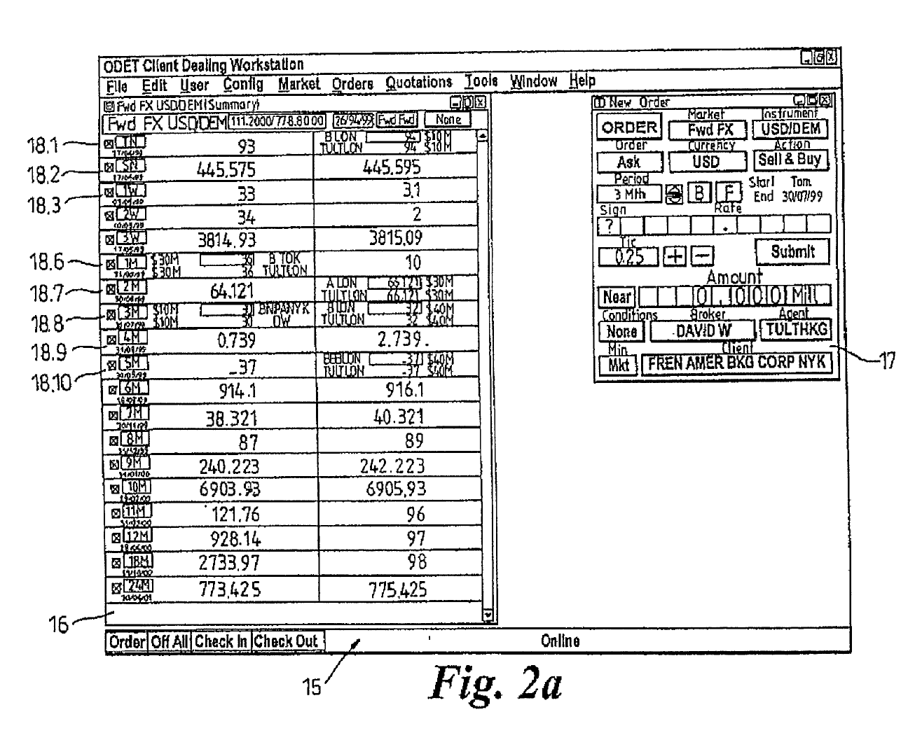

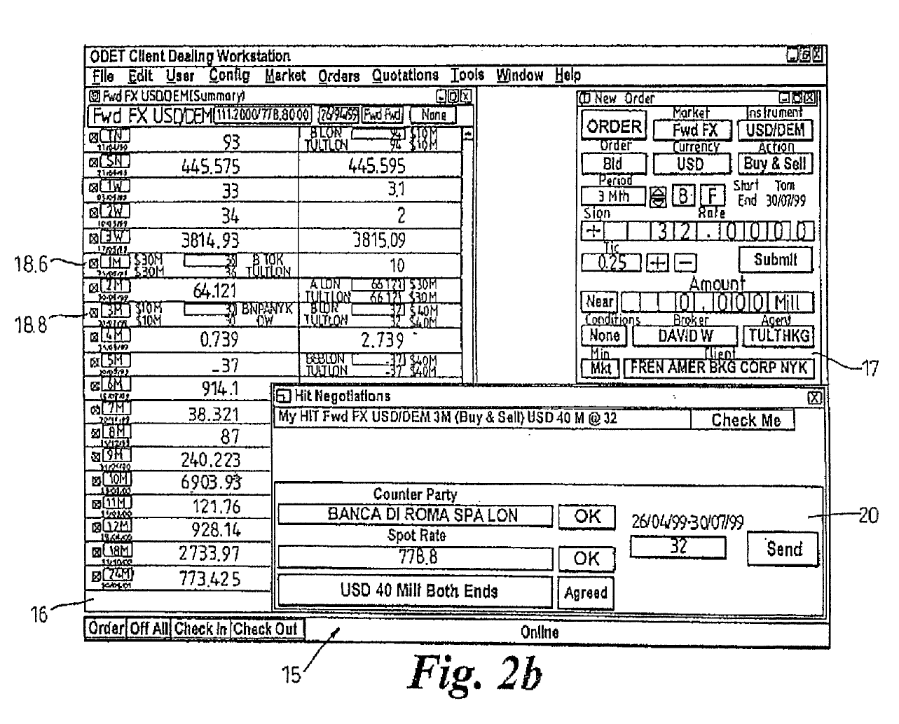

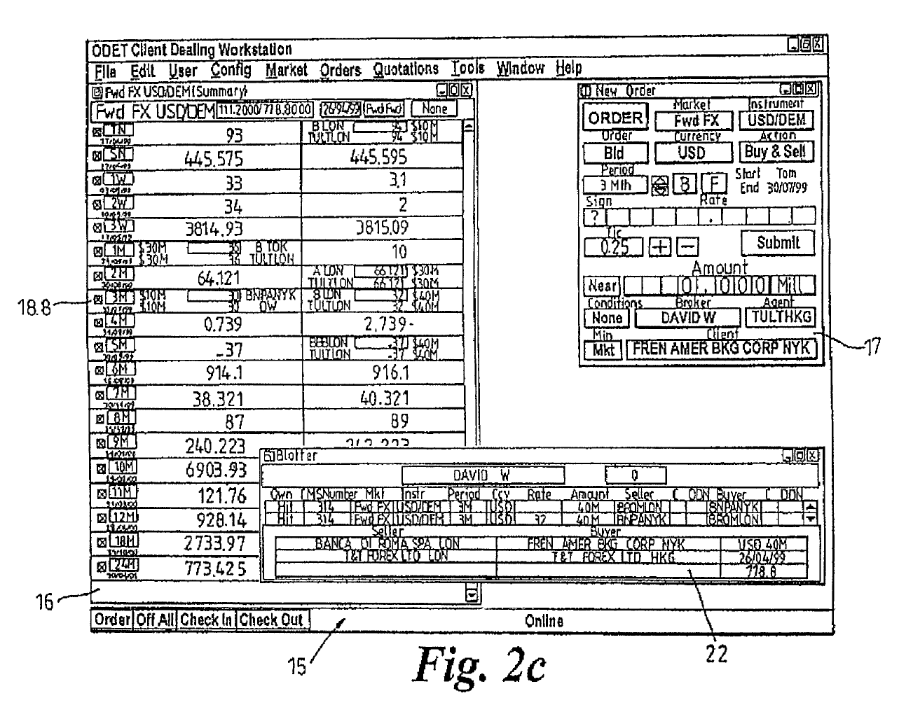

FIGS. 2a to 2c are three exemplary views of the trading information display provided by a workstation;

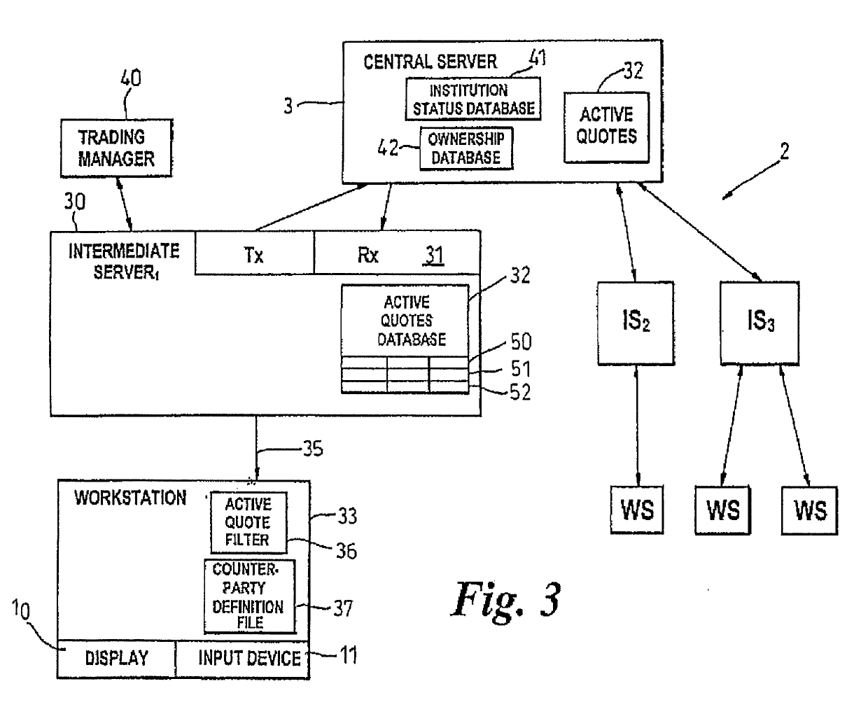

FIG. 3 is a more detailed schematic diagram of the various components of the central server, an intermediate server and a trader workstations of FIG. 1;

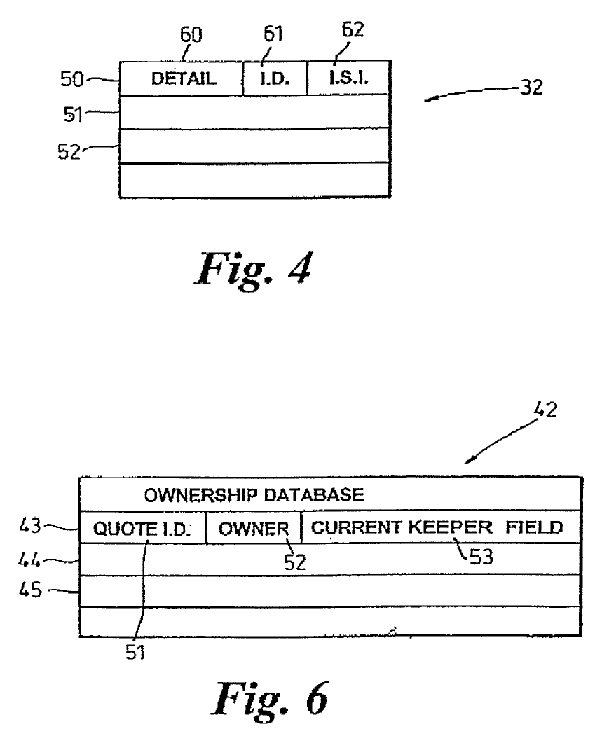

FIG. 4 is a schematic diagram of entries in the active quotes database of FIG. 3;

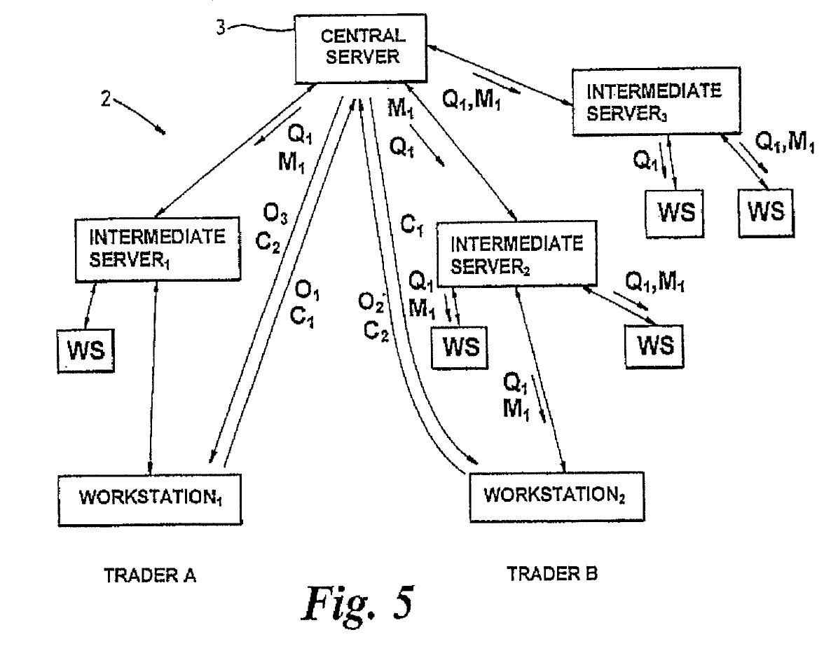

FIG. 5 is a schematic diagram, of the trading system of FIG. 1 showing message data flows, and

FIG. 6 is a schematic diagram of entries in the ownership database of FIG. 3.

With reference to FIG. 1, an exemplary hierarchical structure of a computerised trading system 1 suitable for implementing a preferred embodiment of the present invention is shown.

A plurality of trader workstations WS₁, WS₂ . . . WS₉ are each connected to one or more intermediate servers IS₁, IS₂ . . . IS₃. The intermediate servers IS are all interconnected through a network system 2, which preferably includes a co-ordinating central server 3 or a distributed co-ordinating server system. The central server co-ordinates data flows between workstations and intermediate servers, distributes market information and performs other global functions.

It will be understood that the number of workstations WS and intermediate servers IS is not limited in the present invention which may in principle be implemented with any number thereof. It is possible to eliminate the intermediate servers IS altogether and have the workstations WS connected directly with a central server or network. The functionality of the intermediate servers described in the preferred embodiments could, in many instances, be divided between workstations and the central server or network.

Each workstation WS may typically be associated with a particular trading floor or institution such as a bank, broker or other organisation. For brevity, throughout the present specification, the expression “institution” is used to indicate all such entities that may wish to trade on a computerised trading system network.

In one implementation, each institution is provided with at least one intermediate server IS and its subordinate workstations WS, which is indicated schematically by the box 4 in FIG. 1. The contents of box 4 may, of course, be distributed geographically. In another implementation, the intermediate server IS may be a central computer system with the workstations being provided as simple input and display terminals.

Workstations WS, intermediate servers IS and any central servers 3 may be interconnected over any suitable communication network which can be static (ie. with fixed, permanent connections) or dynamic (ie. with temporary connections) using any known computer network interconnection protocols. Communication between workstations, intermediate servers and any central servers may be by data packet transmission using any of a number of well known transmission protocols with or without suitable security provisions well known in the art of computer networks.

In the embodiment described in connection with FIG. 1, the network 2 includes network links 5 which are continuously open channels while a workstation WS is logged in, and temporary links 6 which are dynamically established to carry specific messages as required.

As shown in FIG. 2, each workstation WS is provided with display means 10 to provide a trader with a display of present market conditions, including details of active quotes which are available. Each workstation also includes a stable input device (not shown) such as a keyboard, mouse, touchscreen or other known devices or combinations thereof.

Although the present invention is described in this specification with reference to a foreign exchange trading environment, it will be understood that the principles of the invention can also be applied to the automated trading of other financial instruments or commodities.

In prior art systems, the trader at a workstation can be presented with a great deal of information which is, in fact, of no significance to him. This is because it relates to bids and offers made by parties with whom he does not wish to trade, or is not permitted to trade. However, where parties making quotes on the system should remain anonymous until a quote is accepted, identification of the redundant information at the intermediate server or workstation level is difficult without compromising anonymity.

In the present invention, a typical series of displays for forward foreign exchange trading in US$ and DEM are shown in FIGS. 2a to 2c. FIG. 2a shows a workstation screen 15 embodying one way of displaying bid and offer quotes in a window 16 on the left hand side of the screen, together with an order input window 17 on the right hand side of the screen.

The quote window 16 displays various periods 18-1, 18-2 . . . 18-n, in which the highlighted blocks shown for periods 18-1, 18-6 . . . 18-8 and 18-10 are orders representing bids or offers of a given quoted price. Also displayed is an amount of currency bid or offered. Entry 18-8 in particular shows both bid and offer on the left and right hand side of the quote window 16.

As also shown in FIG. 2b, entry 18-8 left land side represents a three-month order which has been placed by the trader using the workstation whose window is shown, and therefore includes a short code identifying the input bank “BNPANYK”. By contrast, the other quotes presented are anonymous to the trader in that they simply show a credit rating and location, eg. entry 18-6 “B TOK” and entry 18-10 “BBB LON”.

The order input window 17 allows a trader using the workstation to enter a rate and an amount for placing an order onto the system

FIG. 2b shows the workstation screen 15 of an order “hitter” when an order hit is in progress. In this instance, the trader using the workstation has already indicated his intention to accept (hit) an order, and thus the identity of the order maker has now been revealed to the hitter in the “Hit Negotiations” window 20. Prior to this, the order maker will have seen a similar window on his workstation screen when the order hitter first hit the order. The original order entry 18-8 “B LON” has been cleared while the hit negotiation is in progress and the order hitter now knows that the order maker, previously only identified as credit rating B in London, is in fact “Banca di Roma”.

The workstation display after completion of the hit process shows a window 22 detailing the completed trade, as shown in FIG. 2c. The procedure followed during the making of bids and offers and completion of trades will be described more fully hereinafter.

With reference to FIG. 3, each intermediate server 30 is provided with receiver means 31 to receive details of all bids and offers made by workstations across the network 2, via central server 3.

The details of bids and offers may be transmitted by a broadcast message to all relevant intermediate servers or may be transmitted by a series of messages individually addressed to specific intermediate servers or workstations. In the preferred embodiment, the details of bids and offers will be transmitted only to the intermediate servers or workstations which represent parties interested in that part of the market to which the bid or offer relates (hereafter described as “interested parties”). For example, a USD/YEN trader will not wish to see transaction types such as USD/EUR quotes and therefore will not be registered as an interested party for that part of the market.

The bids and offers are stored as records 50, 51, 52 in an active quotes database 32, the contents of which are made available to each subordinate workstation 33 via transmission means 35.

Workstation 33 is provided with an active quote filter 36 to inhibit the display of bids and offers, in active quote database 32, for which it can be predetermined that the trader (or workstation 33) cannot or will not wish to match.

Because the identity of the party originating each bid or offer is not yet known by the trader or his workstation 33, the active quote filter 36 screens the available current bids and offers in the active quotes database 32 by reference to a plurality of generalized institution status indicators which accompany each active quote record 50.

With reference to FIG. 4, in one embodiment, each active quote record 50 includes: a first set of fields 60 which provide financial and administrative details of the quote; a second field 61 which is a code uniquely identifying the quote; and an institution status field 62 containing one or more institution status indicators.

Each institution status indicator specifies a general attribute of the respective institution, without identifying the institution itself. The institution status indicators generally specify geographical, political, commercial and intra-organisational status of the originating party.

In particular, the indicators may include any or all of the following non-exhaustive list. (1) The country of incorporation of the originating party, or the geographical location of its parent organisation. (2) The liability risk associated with the originating party based on its level within a larger organisation, eg. whether it is a full or sub-branch of a bank. (3) The institutional risk associated with the originating party based on whether it is an officially regulated or non-regulanted organisation, eg. bank etc. (4) The credit risk associated with the originating party, eg. based on an internationally established credit rating from an independent body.

For example, the generalized institution status indicator field 62 might identify the quote 50 as originating from a Japanese bank head office with AA+ credit rating.

To achieve this filtration function, the active quote filter 36 in each workstation 33 is provided with a counterparty definition file 37 (FIG. 3) which stores values or ranges of values of generalized institution status indicators which match trading counterparty types which are not acceptable to the trader, or not acceptable to the institution or client of the trader of that workstation.

By varying the values stored in the counterparty definition file 37, the trader is able to significantly reduce the number of active quotes on his display by elimination of entire classes of originating counterparties' quotes.

For example, a trader or institution may decide to deal only with head office level banks of credit rating AA+ and exclude any domiciled in specified counties.

Still further, the active quote filter 36 and counterparty definition file 37 may also provide means for the trader or institution to filter out quotes on the basis of transaction size. Thus, it would be possible for the trader to implement display criteria such as, eg. “display no offers or bids for an amount greater than x, or less than y”. This filtration may be independent of the generalized institution status indicator or it may be dependent upon values of the generalized institution status indicators, eg. allowing display of offers and bids of a certain size range for London originating quotes, and allowing display of offers and bids of a different size range for other quotes.

The counterparty definition file 37 can be updated at will be the trader to satisfy whichever trading criteria he wishes to operate under at any given time. It would also be possible to have a multiple window display an a single workstation, each window corresponding to a different counterparty definition file so that a trader can operate simultaneously under two or more different trading criteria, eg. in different parts of the market.

It will be understood that the counterparty definition file 37 could be updated not only by the trader operating the workstation 33, but also by a trading manager for the institution with which the workstation is associated. Thus, a trading manager using a control terminal 40 coupled to the intermediate server 30 may be provided with a facility to transmit updates to the counterparty definition file 37 of each workstation associated with that institution. Thus, a change in business strategy can readily be implemented across many workstations simultaneously.

Since the counterparty definition file 37 may contain both individual trader and institution trading preferences, the definition file may equally be located in the intermediate server 30, or split between the workstation 33 and intermediate server 30. A copy of institution and workstation preferences might also be maintained at the central server 3. As previously discussed, the functionality of the active quote filter and counterparty definition file could also be provided entirely or partly at the intermediate server.

With reference to FIG. 4, a trading sequence in the system of the present invention is now described.

Trader A at workstation WS₁ wishes to make a bid to buy or offer to sell currency at a particular rate, and transmits an order instruction O₁ onto the network 2 to central server 3. This may be transmitted via intermediate server IS₁ or preferably by temporary direct connection to the central server 3.

The order instruction O₁ is accepted by the central server and then transmitted as quote Q₁ to all interested parties on the network. Thus active quote databases 32 in each intermediate server 30 are updated accordingly. The order instruction O₁ is allocated a unique identifier which enables the central server to track ownership of the order instruction although this ownership information is not revealed to third parties receiving the quote Q₁. Thus, ownership information will be stripped from the order instruction O₁ before the quote Q₁ is transmitted.

Alternatively, the ownership information could be concealed or encrypted so that it is not generally made available to the workstation at the time the order is displayed.

The transmitted quote Q₁ will, however, provide generalized institution status indicators indicating the status of the originating party. The institution status indicators may be added by the central server 3 by reference to an institution status database 41 or may be provided in the originator order instruction O₁.

Upon receipt of the transmitted quote Q₁, active quote database 32 in intermediate server IS₂ (and any other intermediate savers in the system) adds the record to its database 32. Update information regarding the state of the active quote database 32 is transmitted to each interested party workstation 33 attached to the intermediate server 30, including workstation WS₂.

Dependent upon the current contents of the counterparty definition file 37 in the workstation WS₂, the active quote filter 36 will establish either that the quote originator is a counterparty type with which the trader wants to do business, or that the quote originator is a counterparty with which the trader will not do business. If the latter, the quote Q₁, is not passed on for display on the workstation display 10 (FIG. 2a), and the trader's present display remains unchanged.

Suppose then that the quote Q₁ does pass through the active quotes filter 36 at workstation WS₂, and is displayed on the workstation display (FIG. 2a). Trader B at workstation WS₂ then decides that he wishes to accept the quote, ie. to hit the bid or accept the offer, and issues an order accept instruction O₂ which includes a field identifying the quote Q₁ being accepted.

The order acceptance instruction may also include a field for acceptance conditions such as the proportion or amount of the bid or offer which is being accepted.

The order accept instruction O₂ is passed to central server CS over the network 3, or preferably by temporary direct connection to the central server. The acceptance is forwarded to the trader A at workstation WS₁ as an acceptance message O₃ which includes a data field identifying trader B (or trader B's institution) so that the quote originator A can confirm that he is willing to trade with B as counterpart to the transaction.

If trader A agrees to The order acceptance message O₃, he issues a first confirmation message C₁, which includes an identification of the trader A (or trader A's institution), and which is forwarded by the central server to trader B (FIG. 2b) so that he too can confirm, with a second confirmation message C₂, that he is willing to trade with A as counterparty to the transaction.

The confirmation process may include various counterpart credit checking procedures which can be manual or automated according to methods well established in the art. The counterparty credit checking procedures may be carried out centrally (eg. at the central server 3), or remotely at the respective intermediate servers 30 or workstations 33.

When the transaction is confirmed by both counterparties, the central server 3 transmits messages M₁ to each intermediate server 30 to remove the quote Q₁ from the various copies of the active quote database 32. Updates of this change will be forwarded to update the displays of relevant workstations. The central server 3 also despatches the transaction details to a settlement system (not shown) which may be an independent computer-based system or manual.

As suggested by the exemplary displays in FIG. 2b, the messages M₁ to remove the quote Q₁ from the various copies of the active quotes database may be issued earlier, during the hit negotiation phase. In this instance, if the hit negotiations fail, the quote Q₁ could be automatically reinstated.

The central server 3, which receives the originating order instruction, preferably maintains an ownership database 42 containing records 43, 44, 45 identifying the owning institution and/or trader or workstation for all active quotes on the system.

If a trader needs to temporarily leave his workstation or log out of the trading system for any reason, in prior art systems, he would be required to delete all active quotes on the system. Otherwise, these would be deleted automatically when the central server established that he had logged out or was not responding to order acceptance instructions,

In the present system, an individual trader may effectively transfer ownership of an active quote to another trader, perhaps at an adjacent workstation 33. The central server 3 maintains, associated with each active order record identifier 51, not only an order originator identity field 52, but also a current keeper field 53.

If a trader wishes to transfer responsibility for an active order to another trader, he issues a transfer instruction T₁ to the central server, either directly or via the respective intermediate server. The current keeper record in the ownership database 42 is updated to ensure that any acceptance instructions O₃ are directed to the new owner of the active quote. Thus the trader is able to maintain all of his active quotes on the system through a proxy trader temporarily whilst taking a short break, or can permanently reassign active orders to another trader if required.

It will be understood that ownership and current keeper information database 42 may alternatively be located at the intermediate server level or be distributed between central and intermediate servers.

1. A computerised trading system for the trading of financial instruments or commodities comprising:
a central server or network for connecting a plurality of workstations, each associated with a respective trading floor or institution;
means for storing a plurality of generalized institution status indicators in respect of each trading floor or institution, each indicator indicating a non-specific attribute of the respective institution;
a plurality of trader workstations each connected to the central server or network and associated with a respective institution, each workstation including
means for displaying current quotations in the market place including bids and offers, and
means for generating response messages indicating willingness to accept a bid or offer;
a database maintaining a list of current quotations active on the trading system; and
filtration means for applying selected filtration criteria to inhibit display of current market quotations at a given workstation, based on the value of one or more of said generalized institution status indicators.

2. A computerised trading system according to claim 1 further including a plurality of intermediate servers, each associated with at least one respective institution, for connecting workstations to the central server or network.

3. A computerised trading system according to claim 1 or claim 2 in which the filtration means includes storage means storing a counterparty definition file indicating values of said generalized institution status indicators which match trading counterparties not acceptable to the institution of said given workstation.

4. A computerised trading system according to claim 3 in which the counterparty definition file is stored at said given workstation or at said intermediate server serving said given workstation.

5. A computerised trading system according to claim 4 including means, at the given workstation, for updating the counterparty definition file according to current trader and/or institution preferences.

6. A computerised trading system according to claim 4 including means, remote from a given workstation, for updating the counterparty definition file for said given workstation according to current institution preferences.

7. A computerised trading system according to any preceding claim in which the generalized institution status indicators include one or more of: an indication of geographical origin of the counterparty; an indication of the level of the counterparty within an organisational hierarchy; an indication of the legal status of a counterparty; an indication of the political status of the counterparty; and an indication of an independent credit rating of the counterparty.

8. A computerised trading system according to any one of claims 3 to 7 when dependent from claim 2 in which the database maintaining a list of current quotations active on the trading system is provided at every intermediate server.

9. A computerised trading system according to any preceding claim in which each market quotation transmitted over the trading system includes means for determining said plurality of generalized institution status indicators in respect of the institution originating the quotation.

10. A computerised trading system according to claim 9 in which each quotation transmitted includes originator generalized institution status indicators.

11. A computerised trading system according to claim 9 in which each quotation transmitted to a central server includes an originating party identification, said originating party identification being removed and replaced by generalized institution status indicators prior to receipt by a workstation.

12. A computerised trading system according to claim 1 in which said filtration means further includes means for applying selected filtration criteria to inhibit display of current market quotations at a given workstation, based on the value of one or more transaction type indicators.

13. A computerised trading system according to claim 1 in which said filtration means further includes means for applying selected filtration criteria to inhibit display of current market quotations at a given workstation, based on the financial value of the transaction.

14. A computerised trading system for the trading of financial instruments or commodities comprising:
a central server for connecting a plurality of workstations;
a plurality of trader workstations each connected to the central server, each workstation including
means for generating quotations for transmittal to other workstations via said central server,
means for displaying current quotations in the market place including bids and offers, and
means for generating response messages to originating workstations indicating acceptance of a quotation;
a database maintaining a list of current quotations active on the trading system each quotation having associated therewith an ownership identification field indicating the identity of the originator of the active quotation, and a current keeper identification field indicating the identity of the workstation to which a quote acceptance message should be directed; and
means for modifying the current keeper identification field independent of the ownership identification field.

15. A method of operating an automated trading system for the trading of financial instruments or commodities comprising the steps of:
connecting a plurality of workstations over a network, each workstation being associated with a respective trading floor or institution;
storing a plurality of generalized institution status indicators in respect of each trading floor or institution, each indicator indicating a non-specific attribute of the respective institution;
transmiting transaction data comprising quotations between said plurality of trader workstations over said network;
maintaining a database comprising a list of current quotations active on the trading system;
displaying, on at least one selected workstation, current quotations in the market place including bids and offers;
applying selected filtration criteria to inhibit display of current market quotations at said selected workstation, based on the valve of one or more of said generalized institution status indicators.

16. A computer program product, comprising a computer readable medium having thereon computer program code means adapted, when said program is loaded onto a computer network, to make the computer network execute the procedure of claim 15.

17. A method of operating an automated trading system for the trading of financial instruments or commodities comprising the steps of:
connecting a plurality of workstation via a central server;
generating quotations, by a selected workstation, for transmittal to other workstations via said central server;
displaying, at said workstations, current quotations in the market place including bids and offers;
generating response messages to originating workstations indicating willingness to accept a quotation;
maintaining a database comprising a list of current quotations active on the trading system, each quotation having associated therewith an ownership identification field indicating the identity of the originator of the active quotation, and a current keeper identification field indicating the identity of the workstation to which an quote acceptance message should be directed; and
modifying the current keeper identification field independent of the ownership identification field while the respective quotation is still current.

18. A computer program product, comprising a computer readable medium having thereon computer program code adapted, when said program is loaded onto a computer network, to make the computer network execute the procedure of claim 17.

19. Apparatus substantially as described herein with reference to the accompanying drawings.

20. A method substantially as described herein with reference to the accompanying drawings.
